(19) United States
(12) Patent Application Publication
(10) Pub. No.: US 2009/0123888 A1
(43) Pub. Date: May 14, 2009

(54) UNIVERSAL DENTAL IMPLANT SYSTEM

(76) Inventor: Jeffrey M. Rosenberg, Wynnewood, PA (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 11/940,024

(22) Filed: Nov. 14, 2007

(51) Int. Cl. A61C 8/00

(52) U.S. Cl. 433/173

(57) ABSTRACT

A dental abutment is disclosed for use with a replacement tooth prosthesis. The abutment has a projection that fits generically within the fastener recess of an implant fixture pre-fitted within the patient's jawbone. The projection comprises a solid core surrounded by a plurality of fibers oriented parallel to the core. Resin cement is used to fix the abutment within the implant fixture. Downward pressure pushes the fibers out into intimate contact with the inner surfaces of the fastener recess. The abutment may be a polymer resin, metal, or a combination thereof. The abutment may also have a series of calibrated projections configured to engage corresponding projections of a pre-formed replacement tooth prosthesis to enable quick and precisely aligned installation of the prosthesis. The prosthesis may be a curable resin that is formed or molded in-situ, or it may be pre-manufactured. An installation method and a multi-piece kit are also provided.

### FIELD OF THE INVENTION

The invention generally relates to replacement dental prostheses, and more particularly to a system and method for providing an improved universal dental prosthesis that can be used with a wide variety of dental implant fixtures.

### BACKGROUND

A variety of techniques have been employed to replace or repair damaged, decayed, lost, or removed teeth. The use of complete or removable partial dentures is well-known, as is the use of temporary or permanent crowns. More recently, multi-component replacement teeth have been developed for applications in which one or more teeth are lost or have been completely removed. These multi-component replacement teeth consist of an implant part, engaged in the mandible or maxilla by a surgical procedure, an abutment that is fixed to the implant, for example using a threaded fastener, and a replacement tooth that engages the abutment and typically is fixed to the abutment using cement or screw retention. To install these multi-component systems, the implant is first inserted into the alveolar cavity and must be held there for a period sufficient to allow bone to grow into contact with the implant to fix the implant firmly in place. More recently, immediate “loading” of embedded implant fixtures has been implemented. Over time, the fixture continues to osseo-integrate with the jaw bone. Once the implant fixture is fixed in place, the abutment and replacement tooth can be installed on top of the implant to form the finished prosthesis.

Typically the implant part and the abutment are formed of a metal material, such as titanium, that has desired high strength and is also biocompatible. The replacement tooth is usually a metal ceramic, ceramic or cured polymer, manufactured from a mold of the patient's original tooth or from a substitute that is chosen as an approximation thereof. One benefit of such multi-component systems is that if the replacement tooth or the abutment break, they can be removed and replaced without requiring a new implant to be installed.

While multi-component systems as described provide advantages over traditional bridges or caps, they also have disadvantages. For example, each implant manufacturer typically has a specific screw, implant, abutment, and even screwdrivers, that are proprietary to that company's implant fixture. As a result, the dentist must stock all of that manufacturer's parts, thus increasing expenses. Further, if the prosthesis, abutment, or screw later breaks during usage or is otherwise in need of replacement, the replacement parts must be purchased from the original manufacturer at a premium.

It would be advantageous to provide a multi-piece implant abutment prosthesis that would eliminate the need for the practitioner to stock and purchase all of the individual pieces (and tools) from a particular manufacturer. Such a design would provide the practitioner with increased flexibility in building or repairing implant systems.

### SUMMARY OF THE INVENTION

The disadvantages heretofore associated with the prior art are overcome by the inventive design for a universal multi-piece implant abutment prosthesis.

A dental abutment is disclosed. The abutment may comprise a tooth prosthesis engaging end and an implant engaging end having a longitudinal axis and comprising a core portion surrounded by a fiber containing portion. The fiber containing portion may comprise a plurality of fibers oriented substantially parallel to the longitudinal axis. At least a portion of the tooth prosthesis engaging portion may have an outside dimension greater than an outside dimension of the implant engaging portion.

A tooth prosthesis system is disclosed. The system may comprise a replacement tooth prosthesis and a dental abutment. The dental abutment may have an implant engaging end and a tooth prosthesis engaging end, and the implant engaging end may have a longitudinal axis and comprising a core portion surrounded by a fiber containing portion. The fiber containing portion may comprise a plurality of fibers oriented substantially parallel to the longitudinal axis. At least a portion of the tooth prosthesis engaging portion has an outside dimension greater than an outside dimension of the implant engaging portion.

A method for replacing a lost, damaged or removed tooth is disclosed, comprising: (a) providing an implant fixture having a recess, the implant fixture being engaged with patient bone, (b) providing an abutment having a projection sized to be received within the recess, the projection comprising a core portion and a fiber containing portion, the fiber containing portion comprising a plurality of fibers oriented substantially parallel to a longitudinal axis of the core portion, (c) applying resin cement to one or both of the recess and projection; (d) inserting the projection within the recess of the implant fixture; and (e) applying a tooth prosthesis to an upper surface of the abutment member.

A replacement tooth prosthesis kit is also disclosed. The kit may comprise a plurality of abutment members, at least one of said plurality of abutment members having a size or shape different from at least one other of said plurality of abutment members. The kit may also comprise a plurality of sizing shells configured to measure a size or shape of a tooth vacancy site. A plurality of tooth prosthesis molds may also be provided, where each mold corresponds in size or shape to at least one of said plurality of sizing shells. A quantity of resin material may also be provided. At least one of the plurality of abutment members may comprise a projection having a core portion and a fiber portion, the fiber portion comprising a plurality of individual fibers orientated substantially parallel to a longitudinal axis of the projection. The kit may also contain the a quantity of resin cement for use in bonding the implant engaging end of the abutment into the fixture recess, and/or to bond the tooth prosthesis engaging end of the abutment to the final or interim prosthesis.

A tooth prosthesis system is further disclosed, comprising a replacement tooth prosthesis and a dental abutment. The dental abutment may have an implant engaging end and a tooth prosthesis engaging end. The implant engaging end may have a longitudinal axis and may comprise a longitudinally-oriented projection for engaging a dental implant fixture. An outer surface of the tooth prosthesis engaging end may comprise a plurality of radially-disposed projections, and the tooth prosthesis may have an interior surface comprising a plurality of radially-disposed projections configured to engage the radially-disposed projections of the abutment. The projections of the abutment and tooth prosthesis may have correspondingly oriented surfaces that allow relative movement of the abutment and tooth prosthesis in a first direction and that prevent relative movement of the abutment and tooth prosthesis in a second direction opposite to the first direction.

### BRIEF DESCRIPTION OF THE DRAWINGS

The details of the invention, both as to its structure and operation, may be obtained by a review of the accompanying drawings, in which like reference numerals refer to like parts, and in which:

FIG. 1 is an exploded view of an exemplary dental abutment a dental implant fixture and replacement tooth prosthesis;

FIG. 2 is an isometric view of the abutment of FIG. 1;

FIG. 3 cross-section view of the abutment and implant of FIG. 1, implanted in the mandible of a patient;

FIG. 4 is a cross-section view of the implant/abutment inter-engagement, taken along line 4-4 of FIG. 3;

FIG. 5 is a cross-section view of an exemplary pre-formed replacement tooth prosthesis;

FIG. 6 is an alternative embodiment of a dental abutment;

FIG. 7 is a cross-section view of the abutment of FIG. 6 engaged with an implant fixture set within the mandible of a patient;

FIG. 8 is a cross-section view of an exemplary pre-formed tooth prosthesis and the abutment of FIG. 6, the abutment and tooth prosthesis being in the aligned, but not engaged, position;

FIG. 9 is a cross-section view of the pre-formed tooth prosthesis and the abutment of FIG. 8, the abutment and tooth prosthesis being in a provisionally engaged position;

FIG. 10A is a cross-section view of the pre-formed tooth prosthesis and the abutment of FIG. 8, the abutment and tooth prosthesis being in a fully engaged position; FIG. 10B is a detail view of the engaged prosthesis and abutment of FIG. 10A showing an alternative projection arrangement;

FIG. 11 is a cross-section view of an exemplary two-piece abutment;

FIG. 12 shows a kit for use by a practitioner in employing the system of FIG. 1.

### DETAILED DESCRIPTION

A system and technique are disclosed to enable a dental abutment to engage the screw chamber of a typical dental implant fixture using a generic, close-fitting metal post that is bondable to both fiber and resin. The post may be encased in a fiber sheath made of carbon fiber and resin attractable particles. When the post and sheath are coated with resin cement, it can be placed in any implant screw chamber to form to the chamber. Downward pressure applied to the post expands the fiber sheath into the screw threads of the screw chamber, forming an intimate fit between the post and chamber. The resin cement ensures a long-term, high strength, connection between the abutment and implant fixture. This arrangement eliminates the need for a screw or other fastener to connect the implant and abutment, and it also allows the dentist to use the disclosed abutment with any manufacturer's dental implant fixture without having to stock that manufacturer's entire parts system.

The replacement tooth prosthesis may be made from a metal/ceramic, a ceramic material, or it may be a curable polymer resin. The abutment may either be made from a metal material, or it could also be made from a curable polymer resin that is biocompatible and chemically compatible with the resin selected for the replacement tooth prosthesis to ensure good long term engagement between the two. Where the tooth prosthesis comprises a polymer resin, a quantity of uncured resin may be formed, applied to the abutment and shaped in-situ, then cured in the patient's mouth. Post-cure sculpting of the replacement tooth prosthesis may be performed by the practitioner to provide a final desired tooth shape. Alternatively, a mold may be used in lieu of the in-situ hand forming. Tinting of the final tooth can also be performed.

The disclosed abutment can also be used with a pre-formed or pre-molded tooth prosthesis. In such a case, the tooth prosthesis may either be cemented to the abutment, or a snap-fit arrangement may be provided using pre-formed cooperating projections on both pieces to allow easy installation of the prosthesis on the abutment.

For the purposes of this application, the term “resin” shall mean any of a variety of low shrinkage, polymerizable dental resins. As will be described in greater detail later, the basic resin may be combined with any of a variety of additives, fillers (e.g., particulate and/or fibers), coupling agents, pigments, and the like. Additionally, the resin may be light-curable, chemically curable, or a combination of the two (“dual cured”). In one embodiment the resin will comprise bis-GMA material.

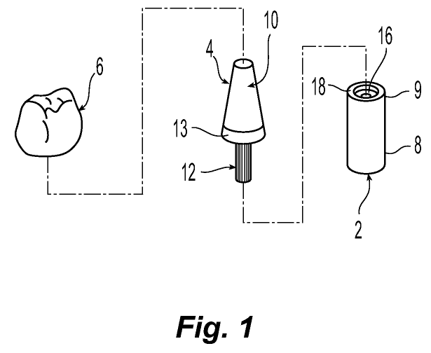

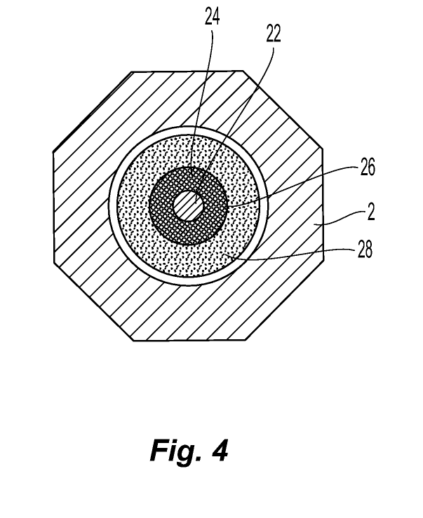

Referring now to FIGS. 1-4, the disclosed abutment will be described in relation to its use with an implant fixture and replacement tooth prosthesis. An implant fixture 2 may comprise an elongated member having a bone engaging portion 8 at a first end and an abutment engaging portion 9 at an opposite end. The bone engaging portion 8 may be sized and shaped to be received within a targeted alveolus of a patient's mandible or maxilla, and may have a surface finish (e.g., knurled, grit blasted) configured to enhance engagement with bone.

For the purposes of this application, the implant fixture 2 may be installed new as part of the same procedure (or sets of procedures) in which the abutment 4 and replacement tooth prosthesis 6 are being installed, or the implant fixture 2 may be a legacy implant (i.e., it may have been previously installed as part of an original procedure along with an original abutment and tooth prosthesis that have since been removed due to damage) to which a new abutment 4 and replacement tooth prosthesis 6 are being attached.

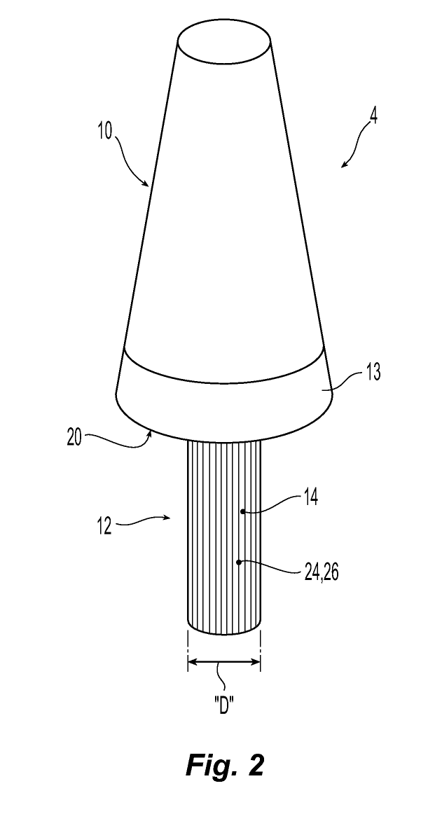

Referring to FIG. 2, the abutment 4 may have a replacement tooth prosthesis engaging portion 10 at a first end and an implant fixture engaging portion 12 at an opposite end. The tooth prosthesis engaging portion 10 should be shaped to provide a large surface area for bonding with the prosthesis 6. In the illustrated embodiment, this portion is shown as having a conical surface, which may be beneficial because it may enable the spreading of forces over a large portion of the abutment 4. It will be appreciated, however, that other appropriate surface configurations may also be used to desirable effect, and thus cylindrical, stepped, and curved surfaces may also be used. The tooth prosthesis engaging portion 10 may have a slightly roughened surface to enhance engagement with the tooth prosthesis 6.

The abutment may further have a smooth surface region 13 disposed between the implant engaging portion 12 and the tooth prosthesis engaging portion 10. This smooth surface region 13 may be located such that when the abutment 4 engages the implant fixture 2, the region 13 is positioned directly adjacent the patient's gum tissue 15. This arrangement will minimize the chance for gum irritation that can occur if a rough surface were presented to the gum tissue 15. A smooth surface may also minimize the chance for bacterial collection that can also lead to gum irritation and/or disease. The smooth surface region 13 may be produced by polishing or other appropriate technique. For example, where the abutment is molded, the smooth surface may be imparted by the mold. In one embodiment, where a Mylar mold is used, the surface finish of the smooth surface region 13 may approach that of the Mylar surface.

The implant fixture engaging portion 12 may comprise an elongated projection 14 sized and configured to be received within a recess 16 (i.e., screw chamber) in the implant fixture 2. In addition to the projection/recess interaction, the implant fixture 2 and abutment 4 may also have complementary flat bearing surfaces 18, 20 that will transmit vertical loads (e.g., biting loads) between the two pieces during use. In the illustrated embodiment, these bearing surfaces 18, 20 are flat, though it will be appreciated that a wide variety of complementary surface configurations may be used to ensure a desired alignment of the abutment 4 on the implant fixture 2. For example, the surfaces could be correspondingly grooved, stepped, or arcuate.

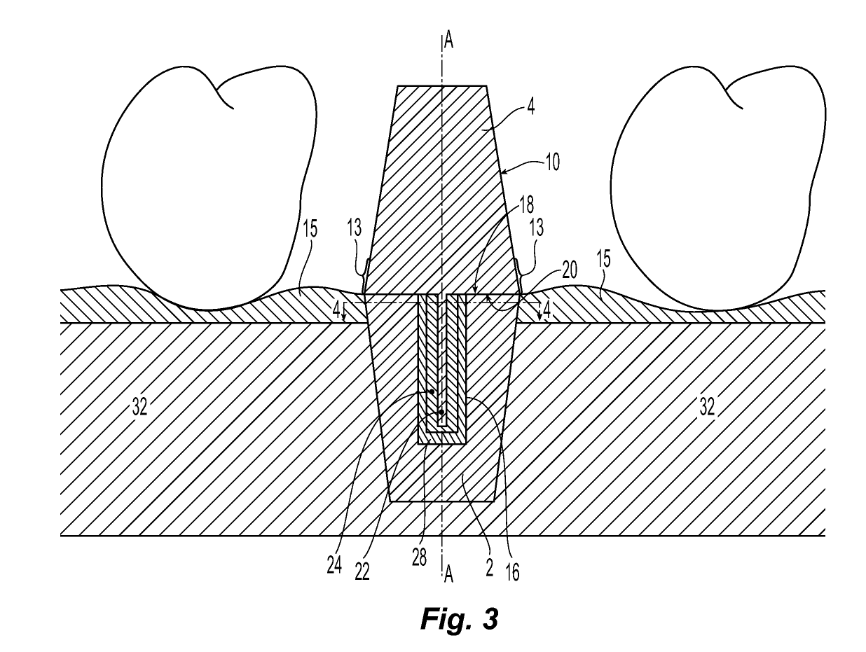

Referring to FIGS. 2, 3 & 4, the projection 14 of the abutment 4 may comprise an elongated cylindrical member having a structural core 22 surrounded by a fiber sheath 24 made from a plurality of fibers 26 oriented substantially parallel to the longitudinal axis A-A of the core 22. The fiber sheath 24 may be embedded in the tooth prosthesis engaging portion of the abutment 4 during formation of the abutment. In one embodiment, the fiber sheath 24 may comprise longitudinal fibers 26 that extend the entire length of the implant engaging portion 12. In an alternative embodiment, the fibers may stop short of the implant engaging portion 20. These fibers may be bonded with resin and resin fillers to form a shear resistant unified structure (fiber sheath 24).

The fibers may have chemically active surfaces that enhance cross-linking with the resin abutment body. In one exemplary embodiment, the fibers may be made of polymer chains having active hydrogen bonds that facilitate cross-linking with other polymers. The fibers 26 may comprise any appropriate fiber material such as carbon fibers, fiberglass, Kevlar (aramid) and the like. Additionally, the individual fibers 26 should be in the range of about 2.0 millimeters (mm) to about 20 mm, to result in the fiber sheath 24 of about 2.1 mm to about 5.5 mm in thickness.

The fiber sheath 24 may further comprise a plurality of resin attractable particles. Such resin attractable particles may be mechanically and chemically active having a lattice structure to form together much like a crystal. This lattice structure is extremely strong, with tensile and compressive strength that allow an immutable engagement in the implant fixture recess/chamber. This engagement occurs when a polymerization reaction occurs between the resin cement and the resin fibers creating a linking of filler particles in the system. The outside diameter “D” of the projection 14 should be sufficiently small that it will be receivable in the recess 14 of the implant fixture 14. Thus, the outside diameter “D” may range from about 2.2 millimeters to about 5.6 millimeters.

It is expected that providing a projection 14 having such an outside diameter will also enable it to be received within the screw chamber (recess 16) of any of a variety of manufacturers' implant fixtures 2. This may be important because it allows the abutment 4 to be used with a variety of different implant fixture designs, and fixation between the abutment 4 and implant fixture 2 will not be dependent upon an inter-fitting screw thread or other such proprietary inter-fitting geometry typical of modern dental implant systems. As such, the abutment 4 can be used as a replacement piece where an original abutment, fixation screw, or tooth prosthesis has broken or otherwise requires replacement, eliminating the need to procure and use only the original manufacturer's replacement pieces, which as previously noted can be very expensive.

In order to facilitate the full engagement of the projection 14 within the recess 16 of the implant fixture 2, a quantity of suitable resin cement 28 may be applied to the outside of the fiber sheath 24 (or within the recess 10) prior to insertion of the projection 14 in the recess 10. Downward pressure applied to the abutment 4 causes the fiber sheath 24 to expand into the screw threads (or other geometry) of the recess 10, resulting in an intimate fit between the implant and abutment. In this way, the fiber sheath, resin cement, and resin attractable particles comprise a matrix that form fits to whatever geometry the recess presents, obviating the need for a complementary screw connection. Curing of the resin cement may be facilitated by an appropriate chemical catalyst.

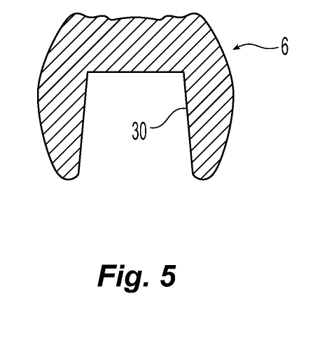

Referring now to FIG. 5, the replacement tooth prosthesis 6 may comprise a volume of composite resin that is shaped, or is shapeable, to assume the form of the tooth that it is replacing. In one embodiment, the prosthesis 6 can be at least partly pre-formed and cured prior to engagement with the abutment 4. Alternatively, the prosthesis 6 may be molded or otherwise wholly formed and cured inside the patient's mouth.

In one exemplary embodiment, the replacement tooth prosthesis 6 is formed using a mold and cured prior to placement in the patient's mouth. The prosthesis of this embodiment may be formed with an abutment-engaging surface 30 that corresponds to the prosthesis-engaging surface 10 of the abutment 4. The prosthesis 6 may be fixed to the abutment 4 using an appropriate cement applied at the interface between the two surfaces 30, 10.

In another exemplary embodiment, the replacement tooth prosthesis 6 may be formed within the patient's mouth. In this embodiment, an appropriately sized and shaped mold may be placed over the abutment 4 (which has already been fixed to the implant fixture 2) and a quantity of uncured composite resin material may be poured or packed into the mold. The composite resin material may then be cured using light energy. A “dual cured” modality could also be used, in which light energy initiates the chemical reaction to allow a full cure over a 1-2 minute time period, to form the finished or semi-finished replacement tooth prosthesis 6. Final finishing of the prosthesis 6 (e.g., by shaving, grinding or carving, as well as by adding further material to fill or enlarge its shape, followed by curing and additional material removal as necessary) may be performed by the practitioner to obtain a final desired tooth form.

In yet another embodiment, the prosthesis 6 may be formed directly on the abutment 4 without a mold. Thus, a quantity of composite resin material may be roughly formed and pressed onto the prosthesis engaging surface 10 of the abutment. The resin may then be cured to create a rough-form prosthesis. The rough-form prosthesis may then be sculpted (by shaving, grinding or carving) to obtain the final desired tooth form.

Referring again to FIG. 3, the composite-resin dental implant abutment/prosthesis system 1 is shown assembled in the mandible 32 of a patient. As can be seen, the patient's gum 15 intersects the system 1 at or near the interface between the implant fixture 2 and the abutment 4. As previously noted, to minimize irritation of the gum 15 and to prevent bacterial buildup adjacent the gum, a lower surface portion 13 of the abutment 4 (and also of the implant 2 as desired) may be polished or otherwise rendered very smooth. Additionally, standard impression techniques can also be used to capture the abutment shape, and an indirect method can be used to make a final resin, ceramic, ceramic/metal or polymer tooth prosthesis 6.

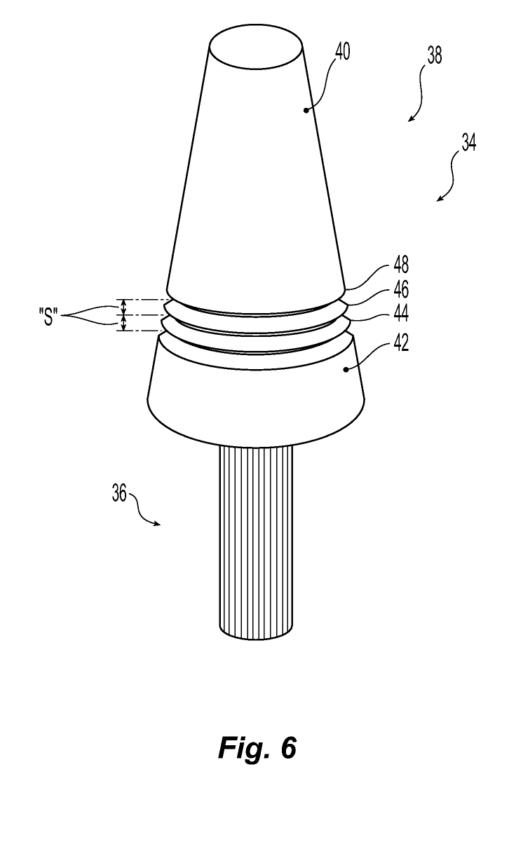

Referring now to FIG. 6, an alternative abutment 34 will be described. Like the embodiment of FIG. 2, the abutment 34 may have an implant engaging portion 36 and a tooth prosthesis engaging portion 38. The implant engaging portion 38 may have any or all of the features described in relation to the implant engaging portion 12 of FIGS. 2-4. Thus, the tooth prosthesis engaging portion 38 should be shaped to provide a large surface area for bonding with the replacement tooth prosthesis. In the illustrated embodiment this portion 38 is shown as having a conical surface, which may be beneficial because it may enable the spreading of forces over a large portion of the abutment 34. The shape may correspond to standard tooth preparation designs used in tooth-borne crown and bridge prosthetics, and thus a variety of appropriate surface configurations may also be used to desirable effect, including cylindrical, stepped, and curved surfaces. The tooth prosthesis engaging portion 38 may have a slightly roughened surface 40 to enhance engagement with the tooth prosthesis.

As with the embodiment of FIGS. 2-4, the abutment 34 may further have a smooth surface region 42 disposed between the implant engaging portion 36 and the tooth prosthesis engaging portion 38. This smooth surface region 42 may be located such that when the abutment 34 engages the implant fixture 2, the region 42 is positioned directly adjacent the patient's gum tissue 15. This arrangement will minimize the chance for gum irritation that can occur where a rough surface is presented to the gum tissue 15. The smooth surface will also minimize the buildup of bacteria adjacent the gum. The smooth surface region 42 may be produced by polishing or other appropriate technique.

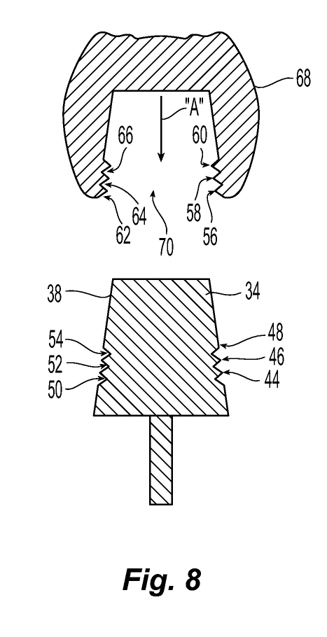

The abutment 34 of FIG. 6 may have additional features to enable a quick and precise connection to a pre-formed replacement tooth prosthesis. To this end, the abutment 34 may have one or more circumferentially disposed projections 44, 46, 48, and recesses 50, 52, 54 configured to mechanically couple to corresponding projections 56, 58, 60 and recesses 62, 64, 66 of the replacement tooth prosthesis 68 (FIG. 8). The projections and recesses of the abutment 34 may be located just above the smooth surface region 42 such that when the replacement tooth prosthesis 68 is fully engaged with the abutment 34, the smooth surface region 42 remains adjacent the patient's gum line.

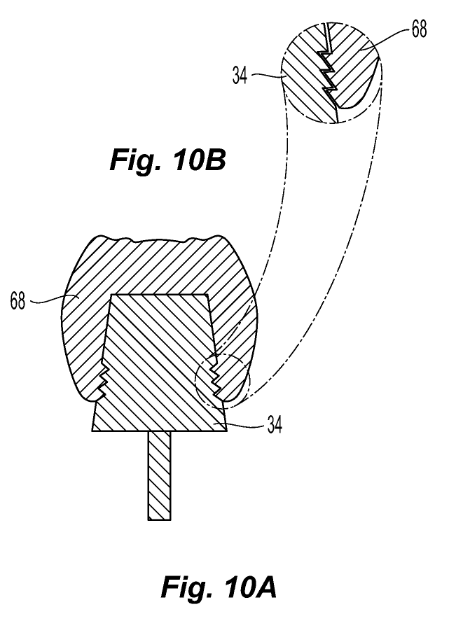

The projections may be configured to create a positive seat and seal when the tooth prosthesis 68 is fully engaged with the abutment 34. The positive sealing enables excess resin to be expressed out from between the prosthesis and abutment for easy cleanup. Thus, the projections may be triangular (see FIG. 10A), or they may be angled on one side an flat on the opposite side (see FIG. 10B), so that when the prosthesis 68 engages the abutment 34, reverse movement is prevented. Adjacent grooves 44, 46, 48 should be spaced from about 0.5 mm apart to about 1 mm apart “S.” This spacing “S” should be calibrated to enable the doctor to measure the gum crevice/implant fixture interface and know how far down to press the tooth prosthesis.

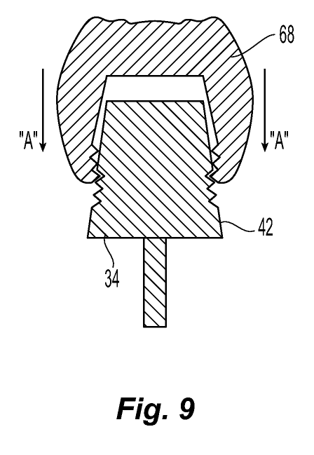

As shown in FIG. 8, the replacement tooth prosthesis 68 may be aligned with the abutment 34 such that the recess 70 of the prosthesis 68 is aligned with the tooth prosthesis engaging portion 38 of the abutment 34. Pressing down on the prosthesis 68 in the direction of arrow “A” causes the respective projections and recesses of the prosthesis 68 and abutment 34 to engage, as shown in FIG. 9. By continuing to apply force along direction “A”, the prosthesis may be set in the fully seated position shown in FIG. 10A. If a resin cement is used between the abutment and the prosthesis, any excess resin will be expressed out of the margin of the seated prosthesis for easy cleanup.

Where a ceramic or ceramic/metal tooth prosthesis 6 is used, an appropriate transfer coping may be used to facilitate indirect fabrication of the prosthesis. The indirectly fabricated prosthesis 6 would be formed with projections appropriate for engaging the abutment recesses 50, 52, 54.

As previously noted, the replacement tooth prosthesis 6, 68 may be made from a composite resin material. The composite resin material may comprise a mixture of relatively soft, organic resin matrix (polymer) in combination with relatively hard, inorganic filler particles or fibers. Other components (e.g., initiators, stabilizers) may also be included to improve the efficacy of the combination and to initiate polymerization. The basic resin material may comprise a monomer such as Bis-GMA, urethane dimethacrylate (UEDMA), or triethylene glycol dimethacrylate (TEGDMA). Bis-GMA may be extremely viscous at room temperature due to hydrogen bonding by hydroxyl groups. Thus, to facilitate the addition of desired filler materials, lower viscosities may be obtained by mixing Bis-GMA with dimethacrylate monomers (TEGDMA) of lower molecular weight. The addition of diluents also allows a greater degree of conversion and more extensive cross-linking to occur between chains, providing a matrix that is more resistant to solvents.

Examples of appropriate particulate filler materials include, but are not limited to, inorganic metal, salt, oxide, nitride, silicate glass, aluminosilicate glass, aluminoborosilicate glass, fluoroaluminosilicate glass, quartz, colloidal silica, precipitated silica, zirconia-silica, polymeric filler, polymerized composite filler with inorganic particles, and combinations thereof. Additionally, a variety of different sizes of filler materials can be used, including megafillers (0.5 to 2 millimeters), macrofillers (10 to 100 microns), midifillers (1 to 10 microns), minifillers (0.1 to 1.0 microns), microfillers (0.01 to 0.1 microns), and nanofillers (0.005 to 0.01 microns). Mixtures of different particle sizes (referred to as “hybrid filler particles”) can also be used.

It will be appreciated that very small particle sizes (microfillers and nanofillers) may have extremely large total surface areas that may demand much more resin matrix to “wet” their surfaces. This may create extremely high viscosities that limit the total percentage of filler content. Thus, to maximize filler loading and minimize viscosity, prepolymerized resin and microfiller may be used. The heavily filled polymerized resin may be ground into 30-65 micron particles and mixed with more resin and microfiller to provide a composite that is filled 30 to 50% by volume.

One exemplary filler is barium glass having average particle size of 0.6 to 1.0 micron. A small amount of microfiller may be added to improve handling characteristics and reduce stickiness. To incorporate a maximum amount of filler into a resin matrix, it may be necessary to use filler particles having a distribution of different particle sizes. These so-called hybrids are potentially superior because increased filler loading improves the stress transfer between particles in the composite, thus improving prosthesis strength and characteristics. In one embodiment, minifill hybrids may be used with nanofillers.

In addition to particulate fillers, a variety of sizes, types and formulations of fibrous materials may be added to the resin material to increase overall strength of the resulting replacement tooth prosthesis. Examples of appropriate fibers include chopped quartz fibers, silica-based (i.e., glass) fibers, as well as Kevlar (aramid) and polycarbonate fibers, ceramic fibers, metallic fibers, carbon fibers, graphite fibers, polymeric fibers such as cellulose, polyamide, aramid, polyester, polyaramid, acrylic, vinyl and modacrylic, polyolefin, polytetrafluorethylene, and combinations thereof, as well as other fibers known in the art

To facilitate efficient bonding of the filler materials (particulate as well as fibers) to the resin matrix, a coupling agent may be employed. The most commonly used coupling agent is an organosilane such as gamma-methacryloxypropyltrimethoxy silane. The silane reduces hydrolytic breakdown and allows stress transfer between the filler and the matrix. The silane agent is a bifunctional molecule with a methacrylate group on one end and a silanol group on the other. The methacrylate end undergoes addition polymerization with the composite resin and the silanol end bonds to the hydroxyl groups on the filler particle via a condensation reaction.

The composite resins are polymerized chemically, and curing may be effected in a number of ways. The reaction may be initiated with a catalyst via mechanical mixing of the base resin with the catalyst, or a photosensitive catalyst (traditionally a tertiary amine radical) such as camphorquinone (CQ). Hardening of the composite resin may be achieved through free-radical polymerization of the (meth)acrylate monomers using a photoinitiator, a heat-cure initiator, or a redox initiator system.

In one alternative embodiment, all or a portion of the abutment 4, 34 may also be made of a composite resin material. As will be appreciated, where multiple pieces are fabricated from composite resin material, the resin material may be the same for multiple pieces, or one or more pieces may be made from a different material or a different formulation of the same material. This will also be true for the additives and/or fillers incorporated into the resin.

In an exemplary alternative embodiment, where it is desirable that the abutment 4, 34 retain high strength characteristics of metal, the abutment 4, 34 may comprise a metal core (e.g., titanium, zirconium) encased in an external coating of composite resin material. This embodiment may combine the strength benefits of metal with the enhanced prosthesis-engaging benefit of composite resin. It is also contemplated that the replacement tooth prosthesis 6 could also have a non-resin core, or it could have a core made from a resin having a different composition than the resin used on the surface.

The implant fixture 2 may be made from an appropriate high strength material, such as metal. Titanium and zirconium are two materials that have good long-term strength and biocompatibility characteristics. Alternatively, the implant fixture 2 may be made from a suitable non-metallic material.

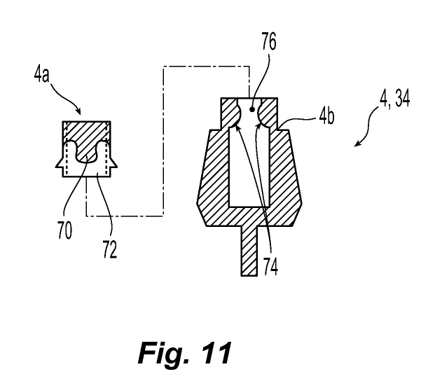

In addition, the abutment 4, 34 may be provided in two pieces 4A, 4B, one of which (4B) may engage the implant fixture 2 and the other of which (4A) may engage the replacement tooth prosthesis 6, 68. This embodiment, shown in FIG. 11, includes a snap-fit connection between the two pieces 4A, 4B. As shown, a depending bulb 70 centrally disposed within a recess 72 in the first piece 4A interferes with an annular shoulder 74 of the second piece 4B. When the first piece 4A is aligned over the second piece 4B such that the depending bulb 70 is received within a top recess portion 76 of the second piece, downward pressure applied to the first piece 4A may cause the bulb 70 to pass by the annular shoulder 74 via slight elastic deformation of the bulb, the shoulder, or both. Once the bulb 70 passes the shoulder 74, return motion of the first piece 4A is prevented via the aforementioned interference, and the first and second pieces 4A, 4B are locked together. It will be appreciated that other connection schemes may also be used to lock the pieces 4A, 4B together, such as ratchets, cementing, screwing, and the like.

The benefit of the FIG. 11 arrangement is that may enable the abutment 4, 34 to be provided with two different materials. Thus, the first piece 4A may be provided as a composite resin material (to provide enhanced engagement with the replacement tooth prosthesis 6), while the second piece 4B may be provided as a metal material (or a resin-coated metal) to provide superior strength for engaging the implant fixture 2.

Where the abutment 4, 34 is made from titanium or zirconium coated with composite resin, the titanium surface may be mechanically or chemically roughened to enhance the connection between titanium and resin materials. Even in cases where the abutment 4, 34 is made from composite resin, or resin-coated metal, the surface of the resin may likewise be mechanically or chemically roughened to enhance the bond between the abutment 4 and the prosthesis 6, 68. Appropriate roughening techniques may comprise acid etching or mechanical abrasion (e.g., blasting with alumina particles). Alternatively, the pieces may be machined (in the case of metal) or molded (in the case of resin) to have a knurled surface that similarly enhances engagement with the composite resin tooth prosthesis 6.

An exemplary installation method for use with the abutment 4 of FIGS. 2-5 will now be described. Where the abutment 4 is used as part of a new installation (i.e., along with a new implant fixture 2), the missing tooth site is first located and a drill used to drill a hole of desired geometry (typically cylindrical) in the patient's mandible or maxilla. The hole may be sized to enable the implant fixture 2 to be installed with a press-fit. The implant is pressed down so that the top surface 18 of the implant fixture 2 is generally aligned with the level of the bone (see FIG. 3). The implant fixture 2 may then be allowed to remain in place for a period sufficient to allow bone to grow around the fixture 2 to firmly fix it within the hole in the bone.

Advanced imaging technology (Computed Tomography (CT) or Cone Beam CT) may be used to visualize the reformed jaw bone. By manipulation of the image data, CAD-CAM guides can be made to locate the missing tooth size, assess the quality of the site, and provide appropriate drills to make exact approximates of the site for simplified fixture placement though the hole in the guide.

Once the implant 2 is sufficiently fixed within the bone, the appropriate abutment 4 may be selected and cemented to the implant using one of the aforementioned techniques or arrangements. The composite resin tooth prosthesis 6 may then be mounted on the abutment 4. As previously noted, this may be accomplished in a variety of ways, such as or in-situ curing and sculpting, in-situ molding, or pre-molding.

In a first example—applicable to either of the disclosed abutment embodiments 4 or 34—a quantity of composite resin material may be roughly formed by the practitioner into a size and/or shape roughly approximating the original tooth. This quantity of resin may be pressed down onto the prosthesis engaging portion 10, 38 of the abutment 4, 34. The resin can be reshaped slightly once it is engaged with the abutment if distortions occur during pressing. Where the resin comprises bis-GMA, a source of light energy may then be introduced adjacent to the patient's mouth to cure the resin into a rough-form tooth prosthesis. Typically this curing process may take 1-2 minutes. The application of light energy will cure (i.e., harden) the resin prosthesis. It will be appreciated that a chemical curing process may also be employed, as can a “dual cured” process of light activating and chemical curing. For embodiments in which the abutment is made from resin (or has a resin coating), this curing will also cause the resin to cross-link with the resin of the abutment 4, 34 providing a high strength bond between the two pieces that will make the prosthesis highly durable. After the rough prosthesis has been cured the practitioner can then use appropriate tools to shave, grind or otherwise sculpt the resin into a finished tooth shape. The prosthesis can then be tinted as desired. Portions of the tooth prosthesis and/or abutment may be polished or otherwise rendered highly smooth where they may engage the patient's gum line. Such polishing reduces the chance for gum irritation which can occur where the gum rubs against a rough prosthesis/abutment surface. It also minimizes bacterial buildup adjacent the patient's gum.

Alternatively, in lieu of providing a rough quantity of resin material over the abutment 4, 34, a mold may be used to provide a more finished form to the replacement tooth prosthesis 6. With this embodiment, the practitioner may place the mold within the patient's mouth and align it over the already-installed abutment 4, 34. The mold may then be packed with composite resin material and cured with light energy or other appropriate chemical curing or dual-curing technique. This arrangement may provide a more finished appearance to the cured prosthesis 6, thereby minimizing the amount of post-cure reworking required. Additionally, where the mold is provided with very smooth inner surfaces, the resulting tooth prosthesis 6 may also be extremely smooth. As a result, the surface over which the prosthesis contacts the patient's gum will be less likely to cause irritation. In one embodiment, the mold is made from Mylar or other material with a similarly smooth surface. Using a Mylar mold may be desirable because it eliminates the need to form a discrete “finish” line on the abutment or tooth prosthesis, because the entirety of the molded prosthesis will be smooth enough to minimize gum irritation and bacterial buildup.

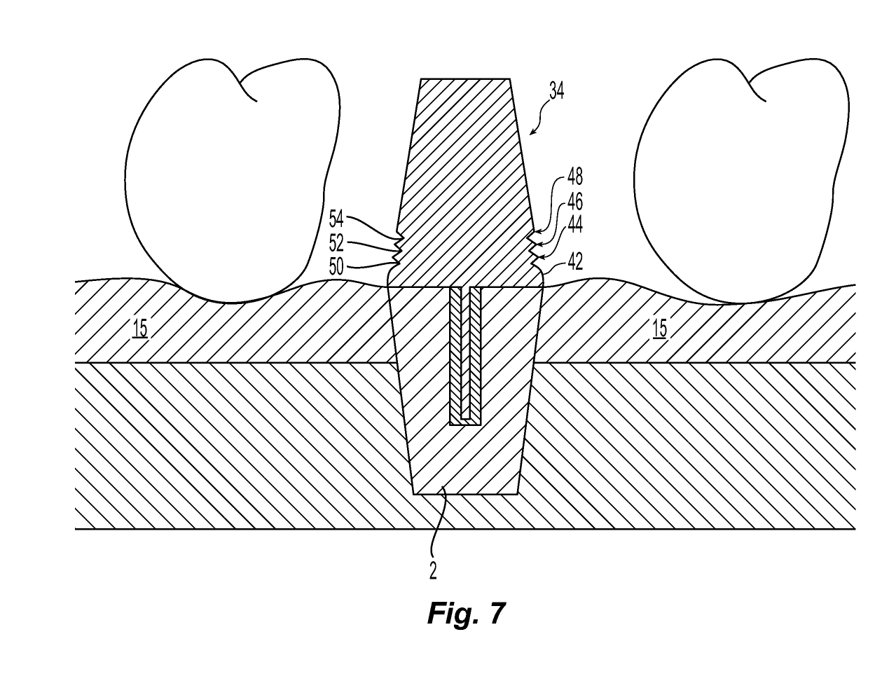

To enhance the mechanical connection between the abutment 4, 34 and the replacement tooth prosthesis 6, it may be desirable to slightly roughen the outer surface 10, 38 of the abutment. This can be done by the manufacturer, or it can be performed by the practitioner using an air abrader (sandblaster) using aluminum oxide particles or the like. In addition, a dilute acid may also be used to slightly etch the surface 10, 38 of the abutment 4, 34.

Where a mold is used to form the prosthesis 6, it may be provided as part of a kit comprising a plurality of individual molds from which the practitioner can select the appropriate size and shape mold to fit the individual patient's anatomy. Alternatively, the practitioner may fashion a patient-specific mold using sheet Mylar or similar ultra-smooth surfaced material.

Where the abutment 34 of FIGS. 6-10 is used, a pre-formed tooth prosthesis 68 may be provided to enable a quick and precise fit for the prosthesis. In such a case, the implant fixture 2 may be installed and engaged with the patient's bone, followed by engagement of the abutment 34 with the implant fixture 2, as previously described. The practitioner may then select an appropriate replacement tooth prosthesis 68 from one or more preformed candidates. Referring to FIG. 8, the selected tooth prosthesis 68 may be positioned over the prosthesis engaging portion 38 of the abutment 34 and pressed down onto the abutment 34 until the projection 48 of the replacement tooth prosthesis 68 engages the projection 56 of the abutment 34. The practitioner may then continue pressing down until the lower-most projection 56 of the tooth prosthesis 68 engages the lower-most recess 50 of the abutment 34. The projections and grooves are calibrated so that connection of the prosthesis 68 to the abutment 34 occurs just at or above the gum 15. This can be done by “feel,” by counting the number of clicks (i.e., the number of projections that have been engaged. Alternatively, a detachable colored band may be used to indicate the depths of the projections. For example, if the top surface of the implant 2 is located 2 mm below the gum 15 (FIG. 3), then an appropriately sized abutment 4 would be selected for installation. The appropriately sized abutment (i.e., the 2 mm size) would bear a detachable color band that corresponds to a 2 mm depth, thus enabling quick and easy selection during the procedure.

Alternatively, even where the abutment of FIGS. 6-10 is used, the replacement tooth prosthesis can be formed within the patient's mouth using either a free forming technique or an in situ molding technique. In either case, the projections 56, 58, 60 of the abutment 34 will serve to enhance the mechanical connection between the abutment 34 and the prosthesis.

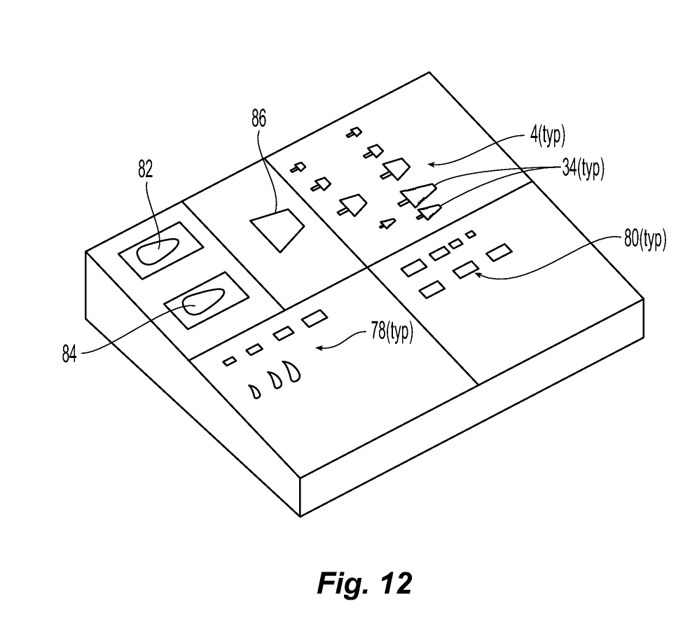

The disclosed system may be provided in individual pieces, or alternatively it may be provided as a comprehensive kit to facilitate fast and easy selection and application of the composite resin dental implant abutment prosthesis system 1. Referring to FIG. 12, a kit may be provided that includes a plurality of abutments 4, 34 for engaging the implant fixtures, and a plurality of molds 78 suitable for forming a wide variety of tooth shapes (e.g., molar, incisor) and sizes. Additionally, the kit may comprise a plurality of sizing “shells” 80 to allow the practitioner to quickly determine what size mold should be selected. For example, the practitioner may select an 8 millimeter (mm) shell 80 and trial fit it into the space between adjacent healthy teeth to determine whether the selected size will provide the most desired fit. This trial fit process will likely involve the selection of several different sized shells prior to finding the right one. Once the appropriate shell size is determined, the mold corresponding to that shell may be selected and placed over the already-installed abutment 4. In one embodiment, the sizing shells may be color coded to cross-reference to the appropriate mold. The kit may further comprise a quantity of composite resin material 82 and a quantity of resin cement 84. Composite resin material may be packed into the mold and cured in a manner similar to that described in relation to the previous embodiment. A transfer coping 86 may also be provided to facilitate fabrication of an appropriate prosthesis using traditional indirect methods.

Abutment selection may be facilitated by a calibrated probe that measures the distance from the top of the implant fixture to the top edge of the individual patient's gum line. An appropriate abutment 4, 34 may then be selected to ensure that when joined to the implant fixture 2, a biologic standard 2-3 mm of space may be provided to the bottom of the abutment finish line. This 2-3 mm space comprises the ultra-smooth portion 13, 42 of the abutment 4, 34 that allows for a healthy gingival response (i.e., minimal gum irritation).

Alternatively, where a plurality of pre-formed replacement tooth prostheses 68 have been provided, the practitioner may use the sizing shells 80 to determine which of the prostheses is the most appropriate for a particular patient. Where a abutment/prosthesis scheme incorporating cooperating projections is used, the selected prosthesis may be pressed down onto the abutment to engage the respective teeth to fix the prosthesis 68 to the abutment 34. Alternatively, if the abutment/prosthesis scheme of FIGS. 2-5 is used, the practitioner may simply use an appropriate cement to fix the prosthesis to the abutment.

An additional benefit of the disclosed system is that it is inherently flexible in that the practitioner is provided with a variety of options in creating a replacement tooth immediately. Additionally, the use of composite resin enables the practitioner to add or subtract material from the prosthesis 6 at any point in the installation process.

It will be understood that the description and drawings presented herein represent an embodiment of the invention, and are therefore merely representative of the subject matter that is broadly contemplated by the invention. It will be further understood that the scope of the present invention encompasses other embodiments that may become obvious to those skilled in the art, and that the scope of the invention is accordingly limited by nothing other than the appended claims.

1. A dental abutment, comprising:
a tooth prosthesis engaging end; and
an implant engaging end having a longitudinal axis and comprising a core portion surrounded by a fiber containing portion, the fiber containing portion comprising a plurality of fibers oriented substantially parallel to the longitudinal axis;
wherein at least a portion of the tooth prosthesis engaging portion has an outside dimension greater than an outside dimension of the implant engaging portion.

2. The dental abutment of claim 1, wherein the abutment comprises a polymer resin.

3. The dental abutment of claim 1, wherein the polymer resin comprises bis-GMA.

4. The dental abutment of claim 1, wherein the implant engaging end further comprises a plurality of resin attractable particles dispersed within the fiber containing portion.

5. The dental abutment of claim 1, wherein the tooth prosthesis engaging end comprises a circumferentially disposed projection configured to engage a tooth prosthesis.

6. The dental abutment of claim 1, wherein the tooth prosthesis engaging end comprises a plurality of circumferentially disposed projections configured to engage a tooth prosthesis.

7. The dental abutment of claim 6, wherein the tooth prosthesis end comprises a polished surface region disposed between the plurality of circumferentially disposed projections and the implant engaging end.

8. The replacement tooth prosthesis system of claim 1, wherein the tooth prosthesis engaging end has a prosthesis engaging portion, and wherein an outer surface of the tooth prosthesis engaging end disposed between the prosthesis engaging portion and the implant engaging end is smoother than the prosthesis engaging portion.

9. A tooth prosthesis system, comprising:
a replacement tooth prosthesis; and
a dental abutment having an implant engaging end and a tooth prosthesis engaging end, the implant engaging end having a longitudinal axis and comprising a core portion surrounded by a fiber containing portion, the fiber containing portion comprising a plurality of fibers oriented substantially parallel to the longitudinal axis;
wherein at least a portion of the tooth prosthesis engaging portion has an outside dimension greater than an outside dimension of the implant engaging portion.

10. The tooth prosthesis system of claim 9, wherein the abutment and replacement tooth prosthesis comprise a resin material.

11. The tooth prosthesis system of claim 10, wherein the resin material comprises bis-GMA.

12. The tooth prosthesis system of claim 9, wherein the tooth prosthesis engaging end comprises a projection configured to engage the tooth prosthesis.

13. The tooth prosthesis system of claim 12, wherein the tooth prosthesis comprises a projection configured to engage the projection of the abutment to retain the tooth prosthesis at a predetermined location on the abutment.

14. The tooth prosthesis system of claim 9, wherein the tooth prosthesis engaging end comprises a plurality of circumferentially disposed projections and the tooth prosthesis has an interior surface comprising a plurality of circumferentially disposed projections configured to engage the projections of the abutment.

15. The tooth prosthesis system of claim 14, wherein the projections of the abutment and tooth prosthesis have correspondingly oriented surfaces that allow relative movement of the abutment and tooth prosthesis in a first direction and that preventing relative movement of the abutment and tooth prosthesis in a second direction opposite to the first direction.

16. The tooth prosthesis system of claim 9, wherein the tooth prosthesis comprises a resin responsive to light energy such that the application of halogen, plasma arc, light emitting diode (LED), ultraviolet (UV) or laser light to a surface of the resin configures at least a portion of the polymer resin material to a cured state.

17. The tooth prosthesis system of claim 16, wherein the abutment comprises resin, and the engagement between the abutment member and the replacement tooth prosthesis comprises cross-linking of the resins.

18. A method for replacing a lost, damaged or removed tooth, comprising:
providing an implant fixture having a recess, the implant fixture being engaged with patient bone;
providing an abutment having a projection sized to be received within the recess, the projection comprising a core portion and a fiber containing portion, the fiber containing portion comprising a plurality of fibers oriented substantially parallel to a longitudinal axis of the core portion;
applying resin cement to one or both of the recess and projection;
inserting the projection within the recess of the implant fixture; and
applying a tooth prosthesis to an upper surface of the abutment member.

19. The method of claim 18, wherein the step of applying a tooth prosthesis comprises applying a quantity of polymer resin material to an upper surface of the abutment member and curing the quantity of polymer resin material using light energy.

20. The method of claim 18, wherein the abutment has a projection configured to engage the tooth prosthesis.

21. The method of claim 20, where the tooth prosthesis has a projection configured to engage the projection of the tooth prosthesis to retain the tooth prosthesis at a predetermined location on the abutment.

22. The method of claim 18, wherein the step of applying a tooth prosthesis comprises positioning a mold adjacent to the abutment and applying a quantity of polymer resin material within the mold.

23. A replacement tooth prosthesis kit, comprising:
a plurality of abutment members, at least one of said plurality of abutment members having a size or shape different from at least one other of said plurality of abutment members;
a plurality of sizing shells configured to measure a size or shape of a tooth vacancy site;
a plurality of tooth prosthesis molds, each mold corresponding in size or shape to at least one of said plurality of sizing shells; and
a quantity of resin material;
wherein at least one of the plurality of abutment members comprises a projection having a core portion and a fiber portion, the fiber portion comprising a plurality of individual fibers orientated substantially parallel to a longitudinal axis of the projection.

24. A tooth prosthesis system, comprising:
a replacement tooth prosthesis; and
a dental abutment having an implant engaging end and a tooth prosthesis engaging end, the implant engaging end having a longitudinal axis and comprising a longitudinally-oriented projection for engaging a dental implant fixture;
wherein an outer surface of the tooth prosthesis engaging end comprises a plurality of radially-disposed projections, and the tooth prosthesis has an interior surface comprising a plurality of radially-disposed projections configured to engage the radially-disposed projections of the abutment; and
wherein the projections of the abutment and tooth prosthesis have correspondingly oriented surfaces that allow relative movement of the abutment and tooth prosthesis in a first direction and that prevent relative movement of the abutment and tooth prosthesis in a second direction opposite to the first direction.
